(19) United States
(12) Patent Application Publication
(10) Pub. No.: US 2002/0056099 A1
(43) Pub. Date: May 9, 2002

(54) INFORMATION PROCESSING APPARATUS, INFORMATION PROCESSING METHOD AS WELL AS BROADCASTING SYSTEM AND BROADCASTING METHOD

(76) Inventors: YASUSHI TAKAHASHI, CHIBA (JP); YOSHIHITO FUJIWARA, KANAGAWA (JP)

Correspondence Address: FROMMER LAWRENCE & HAUG, 745 FIFTH AVENUE- 10TH FL., NEW YORK, NY, 10151, US

(21) Appl. No.: 09/198,691

(22) Filed: Nov. 24, 1998

(30) Foreign Application Priority Data
Nov. 25, 1997 (JP) 09-322777

(51) Int. Cl. G06F 3/00; H04N 5/445

(52) U.S. Cl. 725/39

(57) ABSTRACT

There is provided an information processing apparatus and an information processing method which allow viewers to readily comprehend the contents of a program. Promotion program information correlating information on a promotion program and information on ordinary programs to be promoted by the promotion program is generated in a transmitter and is transmitted together with the ordinary programs, the promotion program and program guide information (EPG). Based on the promotion program information, a receiver correlates and stores the promotion program and the promotion program information about the same ordinary program and provides promotion program-annexed program guide information, i.e., motion image-annexed EPG, in which the program guide information about the ordinary program and the promotion program correlated with the program guide information are composited when the program guide information about the ordinary program is requested.

### BACKGROUND OF THE INVENTION

1. Field of the Invention

The present invention relates to an information processing apparatus and an information processing method as well as a broadcasting system and a broadcasting method and more particularly to an information processing apparatus and an information processing method as well as a broadcasting system and a broadcasting method which allow viewers to readily comprehend the contents of a program for example.

2. Description of the Related Art

The multi-channelization of broadcasting is in progress in the US in the field of cable television (CATV) and Digital Satellite System (DSS) (Trade Mark of Hughes Communications Inc.) through the application of the high-efficient coding technology such as the MPEG (moving picture experts group) code lately. Along with such multi-channelization, a number of channels has increased up to 150 to 200 for example, so that it is not easy for viewers to find a desired program out of them. That is, when there are a large number of channels as described above, leaving a case when there are a few number of channels, the viewer cannot but feel cumbersome when the viewer finds that a selected channel is not desired one after actually confirming its program and is obliged to select another channel.

Then, EPG (electronic program guide) for giving a guide on programs and a program for promoting programs are broadcasted today so that viewers can recognize the contents of a program readily.

Although only programs to be viewed by viewers such as movie programs, news programs and sports programs need to be broadcasted originally as programs (hereinafter referred to as ordinary programs as necessary), it is necessary to promote a program by broadcasting a preview thereof for example in order to let the viewers see it when the ordinary program is a program not known so much or a new program. Here, the program for such promotion will be referred to as a promotion program. While such promotion program is broadcasted sometimes at intervals between the ordinary programs, it is a general practice to set a channel as a channel for exclusively broadcasting promotion programs and to broadcast the promotion programs in that channel when there are a large number of ordinary programs.

It is noted that the multi-channelization is in progress also in Japan lately owing to the relaxation of regulations and the like.

By the way, a guide on ordinary programs are now given in the EPG in the form of text. That is, a list of titles of ordinary programs are shown in the text form in the EPG for example. When a viewer specifies either one title among them, a text explaining the contents of a corresponding program is displayed. Accordingly, the related art method has had a problem that viewers are obliged to read a large number of characters displayed on a screen in order to comprehend the contents of a program, thus taking time and being cumbersome.

It has had another problem that children may not be able to read the text displayed on the screen when Chinese characters are included therein for example.

Further, because the readability of the text is liable to be influenced by the viewing environments such as a receiver and radio conditions, the text might not be able to be read when the radio conditions is bad.

Then, there has been a method of taking one scene or a part of motion images (including sound accompanying it) within an ordinary program into the EPG. Giving the guide on the program by using images allows viewers to comprehend the contents of the program intuitionally and instantly and allows the viewers to understand the contents thereof by a certain degree by pattern recognition of human being even if the radio condition is bad.

However, an mount of data of an image is large as compared to that of a text and it requires a broad band to transmit it. Accordingly, it is not preferable to transmit images for the purpose of only EPG (to use only for EPG) from the point of view of the transmission cost and of that it affects the transmission of ordinary programs.

Meanwhile, the viewers can comprehend the contents of an ordinary program also by viewing the promotion program, beside utilizing the EPG. Because promotion programs are produced often by adding narration and the like to a part of motion images of the ordinary program, the viewers can comprehend the contents of the program intuitionally and instantly by viewing the promotion program more than reading characters as the EPG.

However, because the promotion program broadcasted in a dedicated channel (exclusive channel for promoting programs) is composed of and broadcasted as one program by collecting several motion images for promoting promotion programs, there has been a problem that the viewers are unable to know when the motion image of a desired program is to be broadcasted (the viewers are unable to know when desired program is to be broadcasted also about the promotion programs broadcasted at intervals between ordinary programs). That is, the viewers had to view the dedicated channel for promotion programs continuously in order to view the promotional motion image of the desired program.

### SUMMARY OF THE INVENTION

Accordingly, it is an object of the present invention to provide a system and a method which allow viewers to readily comprehend the contents of a program while avoiding the increase of the transmission cost as much as possible.

An inventive information processing apparatus comprises generating means for generating promotion program information correlating information on a promotion program and information on ordinary programs to be promoted by the promotion program.

An inventive information processing method comprises a step of generating promotion program information correlating information on a promotion program and information on ordinary programs to be promoted by the promotion program.

Accordingly, it becomes possible to allow viewers to readily comprehend the contents of a program by utilizing the promotion program information.

An inventive information processing apparatus comprises storage means for correlating and storing the promotion program and program guide information of the same ordinary program based on the promotion program information and provides promotion program-annexed program guide information in which the program guide information about the ordinary program and the promotion program correlated with the program guide information are composited when the program guide information about the ordinary program is requested.

An inventive information processing method comprises steps of correlating and storing the promotion program and the program guide information of the same ordinary program based on the promotion program information; and of providing promotion program-annexed program guide information in which the program guide information about the ordinary program and the promotion program correlated with the program guide information are composited when the program guide information about the ordinary program is requested.

Accordingly, the viewer can comprehend the contents of the program readily by viewing the promotion program-annexed program guide information.

An inventive broadcasting system comprises a transmitter comprising generating means for generating promotion program information correlating information on a promotion program and information on ordinary programs to be promoted by the promotion program; and a receiver comprising storage means for correlating and storing the promotion program and the program guide information of the same ordinary program based on the promotion program information; and provides promotion program-annexed program guide information in which the program guide information about the ordinary program and the promotion program correlated with the program guide information are composited when the program guide information about the ordinary program is requested.

An inventive broadcasting method comprises steps of generating promotion program information correlating information on a promotion program and information on ordinary programs to be promoted by the promotion program in a transmitter; and correlating and storing the promotion program and the program guide information of the same ordinary program based on the promotion program information in the receiver; and providing promotion program-annexed program guide information in which the program guide information about the ordinary program and the promotion program correlated with the program guide information are composited when the program guide information about the ordinary program is requested.

Accordingly, the viewer can comprehend the contents of the program readily by viewing the promotion program-annexed program guide information.

The specific nature of the invention, as well as other objects, uses and advantages thereof, will clearly appear from the following description and from the accompanying drawings in which like numerals refer to like parts.

### BRIEF DESCRIPTION OF DRAWINGS

FIG. 1 is a block diagram showing the exemplary structure of one embodiment of a broadcasting system to which the present invention is applied;

FIG. 2 is a block diagram showing the exemplary structure of a transmitter in FIG. 1;

FIG. 3 is a diagram for explaining the structure of a promotion program;

FIG. 4 is a block diagram showing the exemplary structure of the hardware of a receiver in FIG. 1;

FIG. 5 is a block diagram showing the functional exemplary structure of the receiver in FIG. 1;

FIG. 6 is a display showing a program selecting screen;

FIG. 7 is a display showing a detailed screen (motion image-annexed EPG);

FIG. 8 is a block diagram showing the other functional exemplary structure of the receiver in FIG. 1; and

FIG. 9 is a display showing a still image listing screen.

### DESCRIPTION OF THE PREFERRED EMBODIMENT

A preferred embodiment of the present invention will be explained below with reference to the drawings.

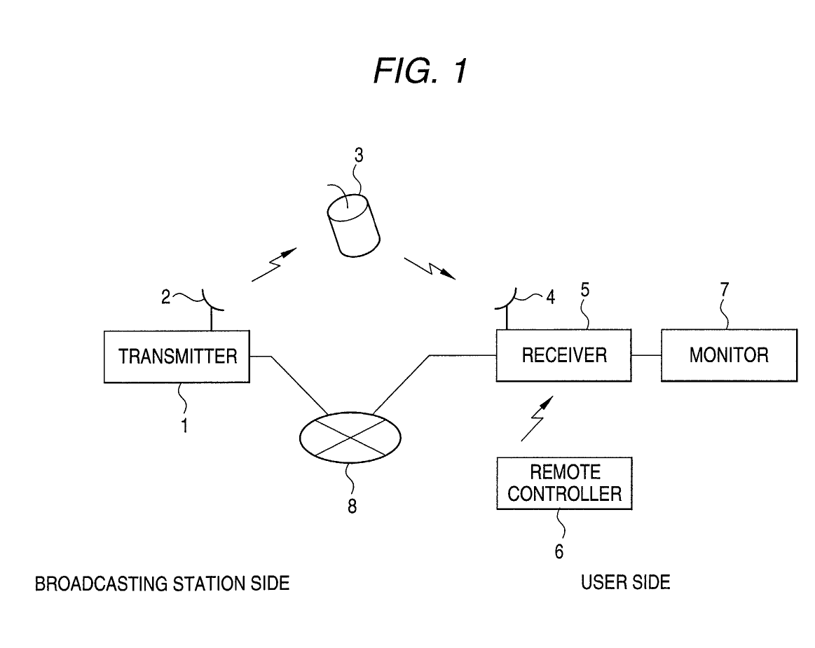

FIG. 1 is a block diagram showing the exemplary structure of one embodiment of a broadcasting system to which the present invention is applied (the system refers to an object in which a plurality of devices are logically congregated and it does not matter whether or not each component is contained in one case).

A broadcasting station generates promotion program information correlating information on a promotion program with information on an ordinary program to be promoted by the promotion program by a transmitter 1. The ordinary program, the promotion program and the promotion program information are multiplexed with EPG data (program guide information) for giving a guide on the ordinary program in the transmitter 1 and are transmitted from an antenna (parabola antenna) 2 as radio waves.

A satellite 3 receives the radio waves and transmits them after implementing necessary processing steps such as amplification by a transponder not shown. An antenna (parabola antenna) 4 of the user (viewer) side receives the radio waves from the satellite 3 and supplies corresponding received signals (transmission data) to a receiver 5.

In the receiver 5, a program in a channel corresponding to that selected by the user by manipulating a remote controller (remote commander) 6 is selected from the signals received from the antenna 4 and is supplied to a monitor 7. The monitor 7 displays the program (picture) from the receiver 5 (sound is outputted from a speaker not shown).

Further, n the receiver 5, the promotion program, the EPG data and the promotion program information are separated from the signals received from the antenna 4 and the promotion program and the EPG data of the same ordinary program are correlated and stored based on the promotion program information. Then, when the user requests the EPG through the remote controller 6, the receiver 5 generates motion image-annexed EPG (promotion program-annexed program guide information) in which the EPG data and the promotion program corresponding to the EPG data are composited and displays it on the monitor 7.

It is noted that there is a case when a PPV (pay per view) program is sent from the transmitter 1. When the user has viewed the PPV program, an accounting process is performed in the receiver 5. This accounting information is transmitted to the transmitter 1 via a public telecommunication network 8 and the like and based on the accounting information, a fee for the PPV program is charged to the user.

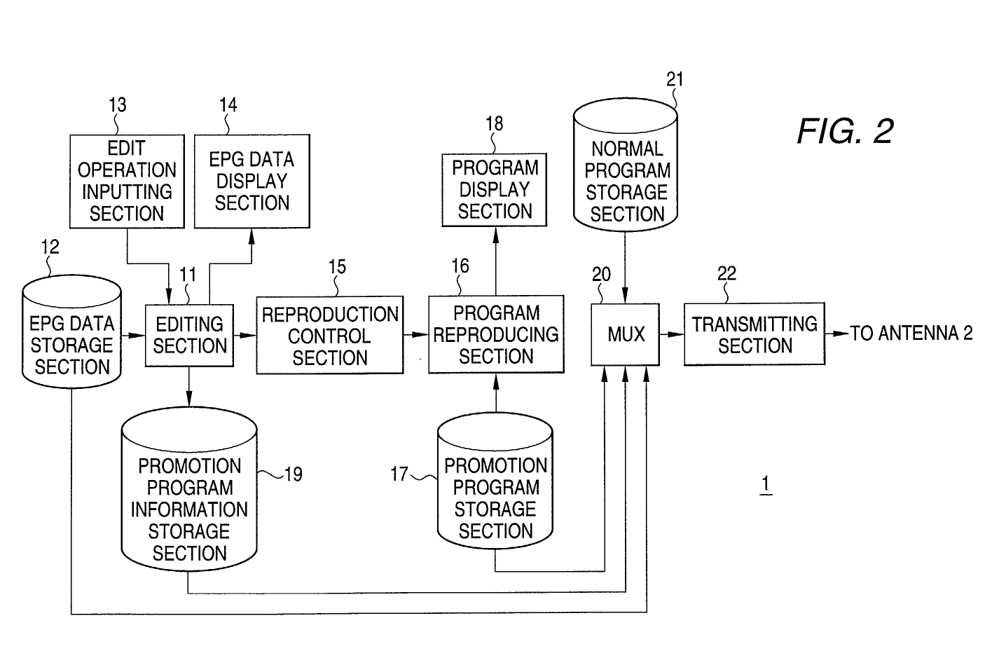

FIG. 2 is a block diagram showing the exemplary structure of the transmitter 1 in FIG. 1.

An editing section 11 may be realized by executing an application program for executing the following processes in a personal computer or the like for example. The editing section 11 is connected with an editing operation inputting section 13 comprising a mouse and a keyboard for example for inputting necessary information and commands and an EPG data display section 14 comprising a CRT (cathode ray tube) or a liquid crystal display for example for displaying EPG data.

EPG data composing EPG composed of a text for example is stored in an EPG data storage section 12. An producer of the broadcasting station reads the EPG data out of the EPG data storage section 12 by manipulating the editing operation inputting section 13 and displays on the EPG data display section 14 via the editing section 11.

Beside the title of an ordinary program and the text for explaining the contents thereof, a service code indicative of a channel broadcasting the ordinary program, an event code specifying that program, broadcasting starting time, a broadcasting time, broadcasting ending time and the like are stored in the EPG data storage section 12 as the EPG data. Such information is displayed on the EPG data display section 14.

Meanwhile, a promotion program storage section 17 is composed of a VCR (video cassette recorder) tape, a DVD (digital versatile disc) tape or a HD (hard-disc) for example and promotion programs to be broadcasted, i.e., so-called completely packaged programs, are stored therein. The promotion program stored in the promotion program storage section 17 is reproduced by a program reproducing section 16 and is displayed on a program display section 18. It is noted that the promotion program is stored while being encoded in the MPEG (moving picture experts group) format for example.

The producer can input commands to the editing section 11 by manipulating the editing operation inputting section 13 and can, thereby, MPEG-decode the promotion program stored in the promotion program storage section 17 to reproduce in the program reproducing section 16 via a reproduction control section 15 as a communication interface conforming to the IEEE (Institute of Electrical and Electronics Engineers) 1394. The promotion program reproduced by the program reproducing section 16 is supplied to and is displayed on the program display section 18.

Then, the producer can input information on the ordinary program and information on the promotion program for promoting the ordinary program to the editing section 11 by manipulating the editing operation inputting section 13 while watching the displays of the EPG data display section 14 and the program display section 18.

That is, the producer can input the service code and the event code of the ordinary program as the information on the ordinary program concerned by making reference to the display of the EPG data display section 14. The producer can input also the service code and the event code of the promotion program as well as broadcasting starting time for starting to broadcast a part for promoting the ordinary program concerned and a broadcasting time (or broadcasting ending time) within motion images composing the promotion program as the information on the promotion program for promoting the ordinary program concerned.

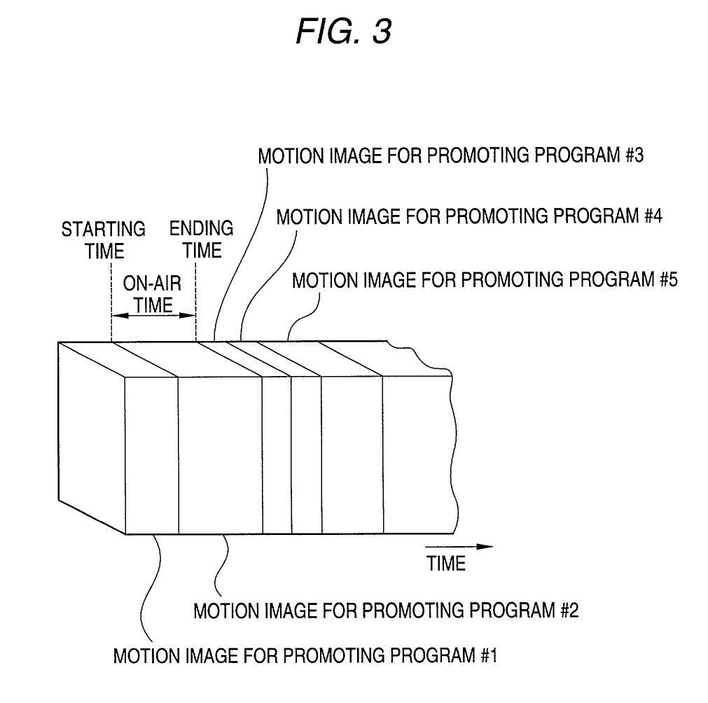

Here, the promotion program is created by collecting several motion images for promoting ordinary programs as shown in FIG. 3. Accordingly, when the ordinary program concerned now is a program #2 in FIG. 3 for example, broadcasting starting time and a broadcasting time of the motion images for promoting the program #2 among the motion images composing the promotion program are inputted beside the service code and the event code of the promotion program as the information on the promotion program.

When the service code and the event code of the ordinary program concerned as well as the service code and the event code, the broadcasting starting time and the broadcasting time about the promotion program for promoting that ordinary program (the broadcasting starting time and the broadcasting time of the part promoting the ordinary program concerned among the motion images composing the promotion program) are inputted, the editing section 11 generates promotion program information for correlating them and supplies it to and stores in a promotion program information storage section 19.

It is noted that beside inputting the concrete values, it is possible to find the broadcasting starting time and the broadcasting time by the following method. That is, the producer inputs starting and ending points of the motion image for promoting the ordinary program concerned while watching the promotion program displayed on the program display section 18. Because the broadcasting starting time of the promotion program is determined in advance, it is possible to cause the editing section 11 to find the broadcasting starting time and the broadcasting time by finding the starting and ending points of the motion image for promoting the ordinary program concerned.

The promotion program information stored in the promotion program information storage section 19 is supplied to a MUX (multiplexer) 20 together with the EPG data stored in the EPG data storage section 12 and the promotion program stored in the promotion program storage section 17. Information stored in an ordinary program storage section 21 is also supplied to the MUX 20. That is, the ordinary programs are MPEG-encoded for example and stored in the ordinary program storage section 21 and are supplied from the ordinary program storage section 21 to the MUX 20.

Necessary information such as the corresponding service code, event code and others are added to the ordinary program from the ordinary program storage section 21 and the ordinary program is multiplexed with the EPG data, the promotion program information and the promotion program in the MUX 20. It is then transformed into an MPEG transport stream for example to be outputted to a transmitting section 22. The signal from the MUX 20 undergoes necessary processes such as scrambling, error-correction, modulation and others in the transmitting section 22 and is outputted to the antenna 2.

Accordingly, as compared to the related art system, although the amount of the data to be transmitted by the transmitter 1 increases by the amount corresponding to the promotion program information, the data amount of the promotion program information is small and the increase of the transmission cost thereof gives no large influence on the transmission of ordinary programs because the promotion program information is composed of the service code and the event code about the ordinary program and the service code, the event code, the broadcasting starting time and the broadcasting time about the promotion program for promoting the ordinary program and contains no image data (the increase of the transmission cost of the promotion program information may be considered to be negligible when the effect given by the promotion program information on the receiver side described later is considered).

It is noted that while there is a case when accounting information is sent to the transmitter 1 from the receiver 5 via the public telecommunication network 8 as described above, the accounting process concerning to the accounting information is performed in a computer not shown.

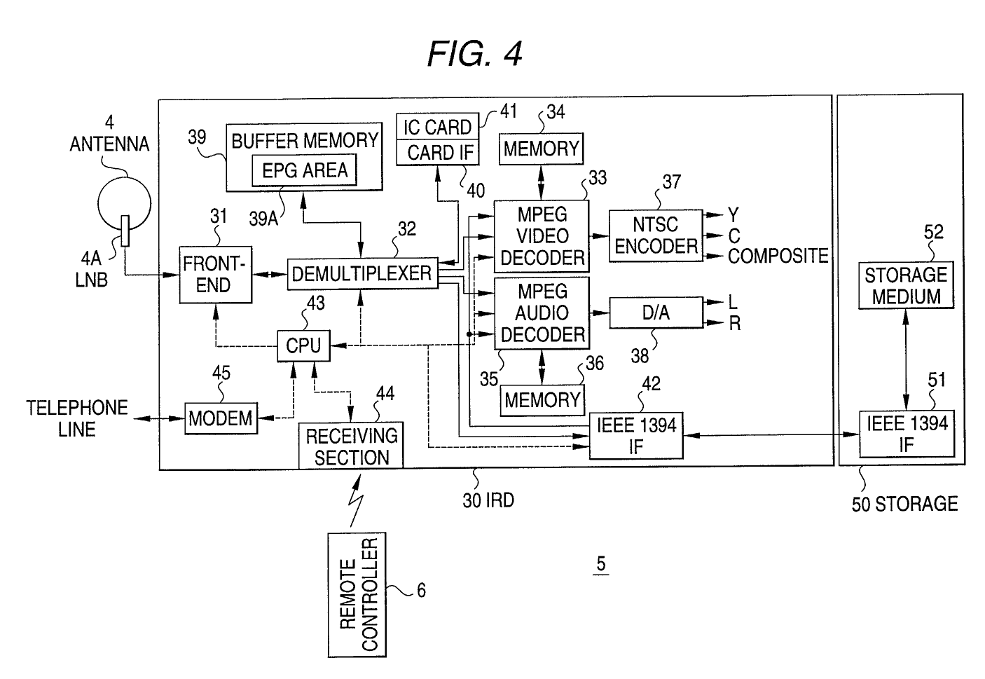

FIG. 4 is a block diagram showing the exemplary structure of the hardware of the receiver 5 in FIG. 1. The receiver 5 comprises an IRD (integrated receive and decoder) 30 and a storage 50 as shown in the figure.

The antenna 4 has an LNB (low noise block down-converter) 4A to down-convert the signal from the satellite 3 into a signal of a predetermined frequency to supply to the IRD 30. The signal from the antenna 4 (LNB 4A) is supplied to a front-end 31 composing the IRD 30 and is outputted from there after undergoing necessary processing steps such as decoding, error-correction and others.

For instance, necessary keys for deciphering (de-scrambling) cryptograph are stored together with a decipherment program in an IC (integrated circuit) card 41 comprising a CPU, an ROM, an RAM and others. Because the broadcasting station (transmitter 1) implements a scrambling process on a program, it is necessary to de-scramble the program to see it. Then, the keys stored in the IC card 41 are read via a card interface (IF) 40 and are supplied to a de-multiplexer 32. Utilizing the keys, the de-multiplexer 32 de-scrambles the scrambled program.

It is noted that the accounting information and others are also stored in the IC card 41 beside the de-scrambling program and the keys required for that.

Receiving the signal (the MPEG transport stream here) outputted from the front-end 31, the de-multiplexer 32 stores it in a buffer memory (composed of an SRAM (static random access memory) for example) 39 once. Then, the de-multiplexer 32 reads the signal as necessary to de-scramble it. Then, when the de-scrambled result is EPG data, the de-multiplexer 32 stores it in an EPG area 39A which is a partial area of the buffer memory 39. When the de-scrambled result is a promotion program or promotion program information, the de-multiplexer 32 supplies it to an IEEE 1394 interface (IF) 42. Receiving the promotion program or the promotion program information from the de-multiplexer 32, the IEEE 1394 interface 42 supplies it to the storage 50.

When the de-scrambled result is an ordinary program, the de-multiplexer 32 supplies picture data and sound data composing the program to an MPEG video decoder 33 and an MPEG audio decoder 35, respectively.

The MPEG video decoder 33 stores the inputted picture data (digital picture data) to a memory 34 composed of a DRAM (dynamic random access memory) and others as necessary to execute the MPEG decoding process. The decoded picture is supplied to an NTSC (National Television System Committee) encoder 37 to be transformed into a luminance signal (Y), a chromatic signal (C) and a composite signal (V) in the NTSC form. These signals are supplied to the monitor 7 to be displayed.

It is noted that the MPEG 2—Transport Stream is explained in “The Latest MPEG Text Book” published by ASCII Co., Ltd. on Aug. 1, 1994, promotion program. 231 through 253.

The MPEG audio decoder 35 stores the digital audio signal supplied from the de-multiplexer 32 to a memory 36 composed of a DRAM and others for example as necessary to execute the MPEG decoding process. The decoded audio signal is converted from digital to analog by a D/A (digital/analog) converter 38 and is outputted via a speaker not shown.

It is noted that when the de-scrambled result is the promotion program, the de-multiplexer 32 supplies the picture data and audio data composing the promotion program also to the MPEG video decoder 33 and the MPEG audio decoder 35 beside supplying to the IEEE 1394 interface 42 as described above. Thereby, the promotion program is also provided to the users (viewers) in the same manner with the ordinary programs.

A CPU (central processing unit) 43 controls the front-end 31, the de-multiplexer 32, the MPEG video decoder 33, the MPEG audio decoder 35, the IEEE 1394 interface 42 and a modem 45.

That is, when a predetermined channel is to be selected for example, the CPU 43 controls the front-end 31. Corresponding to this control, the front-end 31 selects and outputs the signal (packet) of the predetermined channel. Thereby, the monitor 7 displays a program being broad-casted in the predetermined channel.

Further, when predetermined OSD (on-screen display) data is to be generated for example, the CPU 43 controls the MPEG video decoder 33. Corresponding to this control, the MPEG video decoder 33 generates and outputs the predetermined OSD data. Thereby, the monitor 7 displays predetermined characters and graphics, e.g., a cursor, the channel currently selected by the receiver 5, a bar whose length changes corresponding to sound volume and the like, as necessary.

The CPU 43 also controls the de-multiplexer 32 when EPG data is required for example. Corresponding to this control, the de-multiplexer 32 reads the EPG data from the EPG area 39A of the buffer memory 39 and supplies it to the NTSC encoder 37 via the MPEG video decoder 33. Thereby, the monitor 7 displays the EPG in the text form.

The CPU 43 controls the IEEE 1394 interface 42 when information stored in the storage 50 is necessary. Corresponding to this control, the IEEE 1394 interface 42 reads the information from the storage 50 and supplies it to the MPEG video decoder 33 and the MPEG audio decoder 35. Thereby, the monitor 7 displays motion image-annexed EPG and still image EPG as described later.

The CPU 43 controls the de-multiplexer 32 and the modem 45 in transmitting accounting information for example. Corresponding to this control, the de-multiplexer 32 reads the accounting information from the IC card 41 and supplies it to the modem 45 via the CPU 43. Meanwhile, corresponding to the control of the CPU 43, the modem 45 also establishes a link between the transmitter 1 and transmits the accounting information via the public telecommunication network 8.

The CPU 43 is also arranged so as to perform various processes corresponding to a signal from a receiving section 44. That is, when the user manipulates the remote controller 6, infrared rays corresponding to that manipulation are outputted. The receiving section 44 receives and transforms the infrared rays into electrical signals through a photo-electric conversion process. Corresponding to the electrical signals, the CPU 43 performs the various processes, e.g., processes of selecting a channel, displaying EPG as described later and the like.

The storage 50 comprises an IEEE 1394 interface 51 and a storage medium 52 composed of a hard-disk and others for example. The IEEE 1394 interface 51 exchanges promotion programs and promotion program information by communicating with the IEEE 1394 interface 42 composing the IRD 30 under the standard of the IEEE 1394. The storage medium 52 stores the promotion programs and the promotion program information received via the IEEE 1394 interface 51.

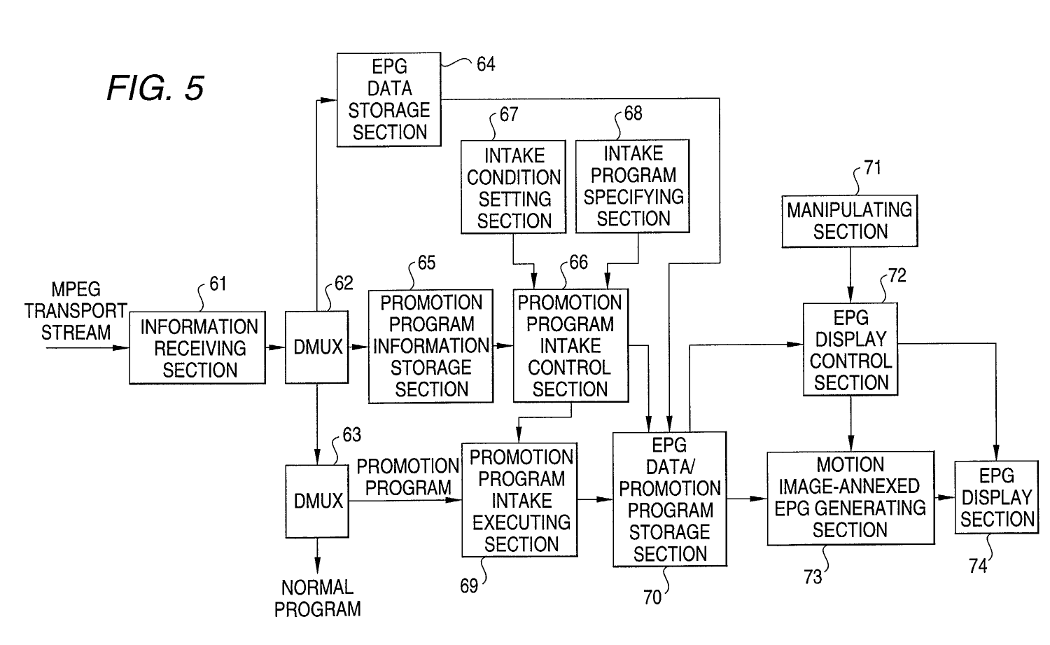

FIG. 5 is a block diagram showing the functional exemplary structure of the receiver 5. It is noted that in FIG. 5, an information receiving section 61 corresponds to the front-end 31 in FIG. 4, DMUXs 62 and 63 correspond to the de-multiplexer 32 in FIG. 4, an EPG data storage section 63 corresponds to the buffer memory 39 in FIG. 4, a promotion program information storage section 65 correspond to the storage 50 in FIG. 4, a promotion program intake control section 66, an intake condition setting section 67, an intake program specifying section 68 and a promotion program intake executing section 69 correspond to the CPU 43 in FIG. 4, an EPG data/promotion program storage section 70 corresponds to the storage 50 in FIG. 4, a manipulating section 71 corresponds the remote controller 6 in FIG. 4, an EPG display control section 72 and a motion image-annexed EPG generating section 73 correspond to the CPU 43 in FIG. 4 and an EPG display section 74 corresponds to the monitor 7 in FIG. 1, respectively.

The information receiving section 61 receives the MPEG transport stream transmitted from the transmitter 1, selects a packet of a predetermined channel and supplies it to the DMUX 62. The DMUX 62 separates programs (both of the ordinary program and the promotion program here), the EPG data and the promotion program information from the output of the information receiving section 61 and supplies them to the DMUX 63, the EPG data storage section 64 and the promotion program information storage section 65. The DMUX 63 separates the programs supplied from the DMUX 62 into the ordinary program and the promotion program. The ordinary program is provided to the user after being MPEG-decoded as explained in FIG. 4. The promotion program is supplied to the promotion program intake executing section 69 (however, when the user selects the channel of the promotion program, the promotion program is also MPEG-decoded and is supplied to the user beside that it is supplied to the promotion program intake executing section 69).

The EPG data and the promotion program supplied from the DMUX 62 are stored in the EPG data storage section 64 and the promotion program information storage section 65, respectively.

The promotion program intake control section 66 controls the promotion program intake executing section 69 based on the promotion program information stored in the promotion program information storage section 65 and on information from the intake condition setting section 67. Thereby, the promotion program intake executing section 69 takes out only necessary motion images (including sound accompanying to that) from the promotion program outputted from the DMUX 63.

That is, intake conditions in taking in the motion images from the promotion program outputted from the DMUX 63 are set in the intake condition setting section 67. In concrete, the title of an ordinary program to be promoted by the motion images to be taken in is set as the intake condition at first. It is set in the intake condition setting section 67 when the user inputs the title of the ordinary program by manipulating the remote controller 6 for example when the user wants to see the motion images for promoting the ordinary program.

A time for taking in the motion image (hereinafter referred to as motion images to be taken in as necessary) in taking in the motion images for promoting the ordinary program (e.g., 30 seconds, one minute or two minutes from the start or the whole motion image to be taken in) and a mode in taking in the motion image to be taken in (e.g., whether all pixels of the image should be taken in without culling or partial pixels should be taken in by culling with a rate of culling of a quarter for example and whether the sound quality should be monoral sound or stereo sound) are also set as the intake conditions. It is noted that the user can set the intake time and the intake mode in the intake condition setting section 67 by manipulating the remote controller 6 in the same manner with the case of the title of the ordinary program to be promoted by the motion image to be taken in.

The promotion program intake control section 66 reads the intake conditions (the title, the intake time and the intake mode in the above-mentioned case) set in the intake condition setting section 67 and recognizes the event code and the service code of the corresponding ordinary program from the title of the program as the intake condition. The promotion program intake control section 66 also reads the promotion program information having the codes which coincide with the event code and the service code of the ordinary program as the service code and the event code of the ordinary program from the promotion program information storage section 65 and recognizes the service code and the event code as well as the broadcasting starting time and the broadcasting time (these are the broadcasting starting time and the broadcasting time of the motion images to be taken in from the fact described above) of the promotion program correlated to the service code and the event code of the ordinary program.

Then, the promotion program intake control section 66 outputs the service code and the event code of the recognized promotion program, the broadcasting starting time and the broadcasting time of the motion images to be taken in and the intake time and the intake mode of the intake conditions to the promotion program intake executing section 69.

The promotion program intake executing section 69 selects a promotion program having the service code and the event code which coincide with the service code and the event code supplied from the promotion program intake control section 66 from the output of the DMUX 63 at first. Then, the promotion program intake executing section 69 starts to take in the motion images to be taken in from the motion images composing the selected promotion program from the timing of the broadcasting starting time supplied from the promotion program intake control section 66. This intake is carried out for a time corresponding to the intake time in accordance to the intake mode and the taken-in motion images are supplied to the EPG data/promotion program storage section 70.

That is, thereby, only the motion images promoting the ordinary program specified by the user are supplied to the EPG data/promotion program storage section 70.

It is noted that the promotion program intake executing section 69 contains a clock and counts a concrete time when the concrete time is set as the intake time based on that clock. When the “whole motion images to be taken in” is set as the intake time, the promotion program intake executing section 69 takes in the motion images only for a time corresponding to the broadcasting time supplied from the promotion program intake control section 66. The intake conditions once set may be kept effective until when they are changed later or the intake conditions may be nullified after motion images are taken in based on the intake conditions once set until when the conditions are set again (accordingly, the intake conditions need to be set every time in this case).

Although the title of the ordinary program has been set as the intake condition in taking in the motion images (promotion program) promoting the ordinary program in the above-mentioned case, there is a case when the title is unknown when the ordinary program is a new program for example. It is also cumbersome for the user to input the individual title as the intake condition.

Then, the system of the present embodiment is arranged so as to specify a corresponding ordinary program and to take in motion images promoting the ordinary program when the user inputs his/her favorite channel, program genre, broadcasting time zone and the like. That is, when the user inputs the favorite channel, program genre, broadcasting time zone and the like by manipulating the remote controller 6, the intake program specifying section 68 specifies the ordinary program corresponding to that input and outputs its title to the promotion program intake control section 66. At this time, the promotion program intake control section 66 controls the promotion program intake executing section 69 based on the title sent from the intake program specifying section 68 and thereby, the promotion program intake executing section 69 takes out (taken in) the motion images from the promotion program outputted from the DMUX 63.

The system of the present embodiment is also arranged so that the user can input own age, sex and other profiles by manipulating the remote controller 6. The profiles of the user are stored in the intake program specifying section 68 and an ordinary program suited to the taste of the user is presumed from the profiles. The intake program specifying section 68 outputs the title of the presumed ordinary program to the promotion program intake control section 66. Then, the promotion program intake executing section 69 takes in the motion images promoting the ordinary program presumed from the profiles of the user.

The system of the present embodiment is also arranged so as to store the history (viewing history) of programs viewed by the user in the intake program specifying section 68 to presume an ordinary program suited to the taste of the user from the viewing history. The intake program specifying section 68 outputs the title of a presumed ordinary program to the promotion program intake control section 66. Then, the promotion program intake executing section 69 takes in the motion images promoting the ordinary program presumed from the viewing history of the user.

It is noted that it is possible to take in the motion images composing the promotion program, i.e., the whole promotion program. However, because the motion images taken in are stored in the EPG data/promotion program storage section 70 as described later, only the motion images promoting the ordinary program desired (or presumed to be desired) by the user are taken in to reduce the storage capacity and to effectively utilize the EPG data/promotion program storage section 70.

The methods of presuming the program suited to the taste of the user intelligently, so to speak, from the profiles or the viewing history of the user have been described in detail in Japanese Patent Application Nos. Hei. 8-334517, Hei. 8-334978 and Hei. 8-334979 for example which have been applied before by the applicant of the present invention.

Receiving the motion images (the motion images as the promotion program) from the promotion program intake executing section 69, the EPG data/promotion program storage section 70 stores the motion images by linking with the corresponding EPG data based on the control from the promotion program intake control section 66.

That is, beside controlling the promotion program intake executing section 69 so as to take in the motion images based on the promotion program information and others stored in the promotion program information storage section 65 as described above, the promotion program intake control section 66 controls the EPG data/promotion program storage section 70 in the same time so as to specify the EPG data corresponding to the ordinary program from the service code and the event code of the ordinary program held by the promotion program information and so as to read the EPG data from the EPG data storage section 64.

In accordance to the control from the promotion program intake control section 66, the EPG data/promotion program storage section 70 retrieves and reads the EPG data from the EPG data storage section 64 (the EPG data corresponding to the ordinary program to be promoted by the motion images outputted by the promotion program intake executing section 69) and stores it while correlating with the motion images outputted by the promotion program intake executing section 69.

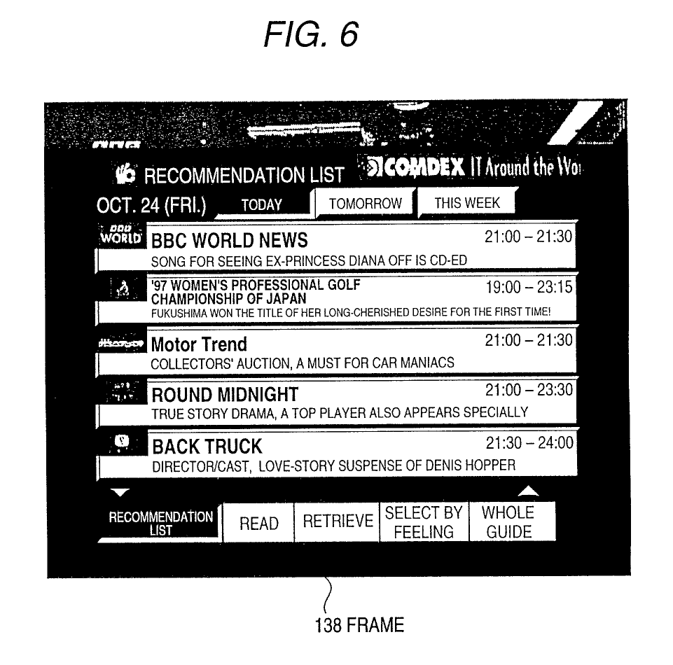

When the user manipulates the manipulating section 71 so as to display EPG of a list of titles for example after when the information in which the EPG data and the motion images (the motion images as the promotion program) about the same ordinary program are linked has been stored in the EPG data/promotion program storage section 70, the EPG display control section 72 retrieves and reads the title, the broadcasting starting time and the broadcasting ending time of the ordinary program composing the EPG data from the EPG data/promotion program storage section 70, composes a screen for selecting a program (hereinafter referred to as a program selecting screen as necessary) on which those data are disposed and outputs it to the EPG display section 74. Thereby, the program selecting screen in which the title, the broadcasting starting time, the broadcasting ending time and others of the ordinary programs are disposed in the form of a list as shown in FIG. 6 is displayed on the EPG display section 74.

It is noted that because it becomes difficult for the user to find a desired program when the program selecting screen is composed by using all of the EPG data stored in the EPG data storage section 64, the EPG data used to compose the program selecting screen is limited by the conditions of the genre of a program, a channel, programs broadcasted today or tomorrow for example. When there are so many programs that the titles and others of the programs cannot be displayed at once on the program selecting screen, the programs which cannot be displayed on the screen may be displayed by scrolling the screen.

The system is also arranged such that the title part of the program for example displayed on the program selecting screen may be selected by manipulating the manipulating section 71. For instance, when the user manipulates the manipulating section 71 to select a program to know the detail thereof, a screen detailing the program (hereinafter referred to as a detailed screen as necessary) is displayed instead of the program selecting screen.

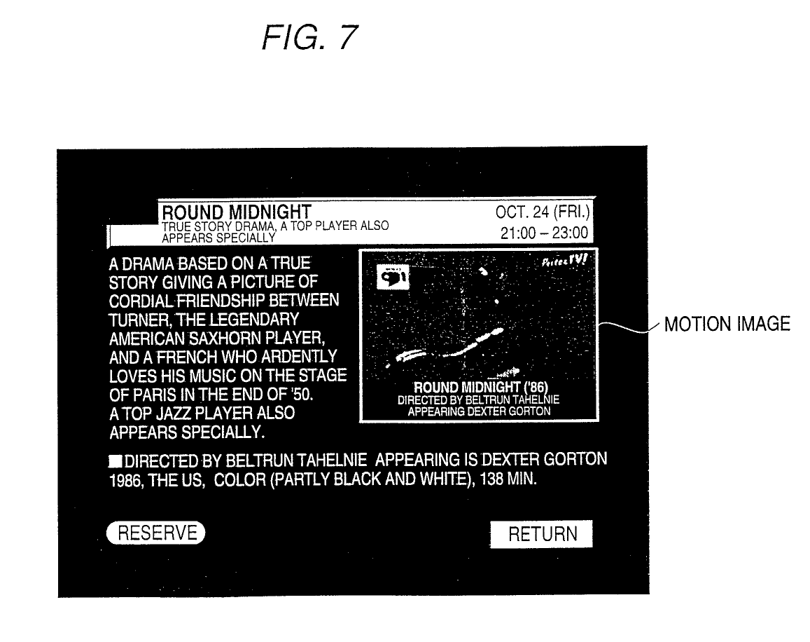

That is, when the user selects a program on the program selecting screen, the EPG display control section 72 retrieves the motion images (the motion images as the promotion program) linked to the EPG data together with a text for giving a guide (explaining the contents of the program) (hereinafter referred to as a guide text) which composes the EPG data of the selected program from the EPG data/promotion program storage section 70 and supplies them to the motion image-annexed EPG generating section 73. Receiving the guide text and the motion images, the motion image-annexed EPG generating section 73 composes the detailed screen in which they are disposed and outputs it to the EPG display section 74. Thereby, the EPG display section 74 displays the detailed screen as the motion image-annexed EPG in which the motion images produced as the promotion program are disposed beside the guide text as shown in FIG. 7 for example (when there exists sound accompanying to the motion image, the sound is also outputted).

Accordingly, because the user can see not only the guide text which is a character string giving a guide on the ordinary program but also the motion images as the promotion program promoting that program, the user needs not to always read the large number of characters displayed on the screen to comprehend the contents of the program and can comprehend the contents of the program readily and quickly or intuitionally or sensorially by viewing the motion images.

It also allows children who are not accustomed to read Chinese characters to comprehend the contents of the program.

Further, although the readability of characters is liable to be influenced by the viewing environments such as the receiver and the radio condition, the user can recognize the contents of the program by a certain degree by viewing the motion images even in the circumstance in which the radio condition is bad and it is difficult to read the guide text because human being can comprehend the contents by a certain degree by the pattern recognition of the human being even if the details of an image is not clear.

When the user tries to view the promotion program itself, the user had to set to the time when the promotion program is broadcasted in the past as described before. Further, because the promotion program is normally composed and broadcasted by collecting several motion images for promoting ordinary programs, the user was unable to know when the motion images promoting the program desired by the user is to be broadcasted even if the user starts to see the promotion program from when it is started to be broadcasted. Therefore, the user was often restrained for a considerable period of time to view the motion images promoting the program aimed by the user in the past. In contrary to that, the receiver 5 described above allows the user to view the motion images promoting the objective program at any time.

Although the transmission cost increases by the amount of data of the promotion program information as compared to the related art system, the promotion program information allows to take out the motion images for promoting the ordinary program individually from the promotion program and to provide the motion image-annexed guide text (detailed screen) without transmitting images for composing the detailed screen separately. That is, considering of transmitting the images for composing the detailed screen separately, the transmission cost is reduced in contrary when it is compared with the case of transmitting the images because the data amount of the image is large as compared to the promotion program information.

Further, although the study on image processing for compressing the contents of a broadcasting program into a short time is in progress, no system for automatically generating meaningful pictures (pictures from which users can recognize the contents of the program) costly on the receiver side is realized yet at the present. In contrary to that, the receiver 5 described above allows to provide the motion image-annexed guide text without separately generating the images composing the detailed screen.

Meanwhile, the broadcasting station can promote the ordinary programs effectively at low cost by utilizing the same material (the motion images as the promotion program) just by generating the promotion program information. Further, the broadcasting station can set the starting and ending points of the motion images composing the promotion program to be inputted in generating the promotion program information at any position and accordingly, the broadcasting station can present what is intended as the motion images to be disposed on the detailed screen to the user.

It is noted that in the detailed screen in FIG. 7, “Reservation” button is manipulated in starting to receive a program in the same time when the program guided or promoted by the detailed screen is started. “Return” button is manipulated in returning to the program selecting screen in FIG. 6.

It is also possible to include time when one scene in the motion images is to be broadcasted (hereinafter referred to as a scene broadcasting time as necessary) in the promotion program information instead of or together with the broadcasting starting time and the broadcasting time of the motion images promoting the ordinary program in the transmitter 1. It is noted that the producer can input the scene broadcasting time to the editing section 11 by manipulating the editing operation inputting section 13. Thereby, the scene broadcasting time may be included in the promotion program information in the editing section 11. It is noted that when the motion images promoting the ordinary program are broadcasted in the MPEG form, any time when I picture is broadcasted is specified for example as the scene broadcasting time.

In this case, the receiver 5 in FIG. 5 may be arranged so as to store one scene composing the motion images broadcasted at the scene broadcasting time instead of or together with the motion images of the promotion program and to compose the detailed screen in FIG. 7 by disposing that one scene, i.e., a still image, instead of the motion images.

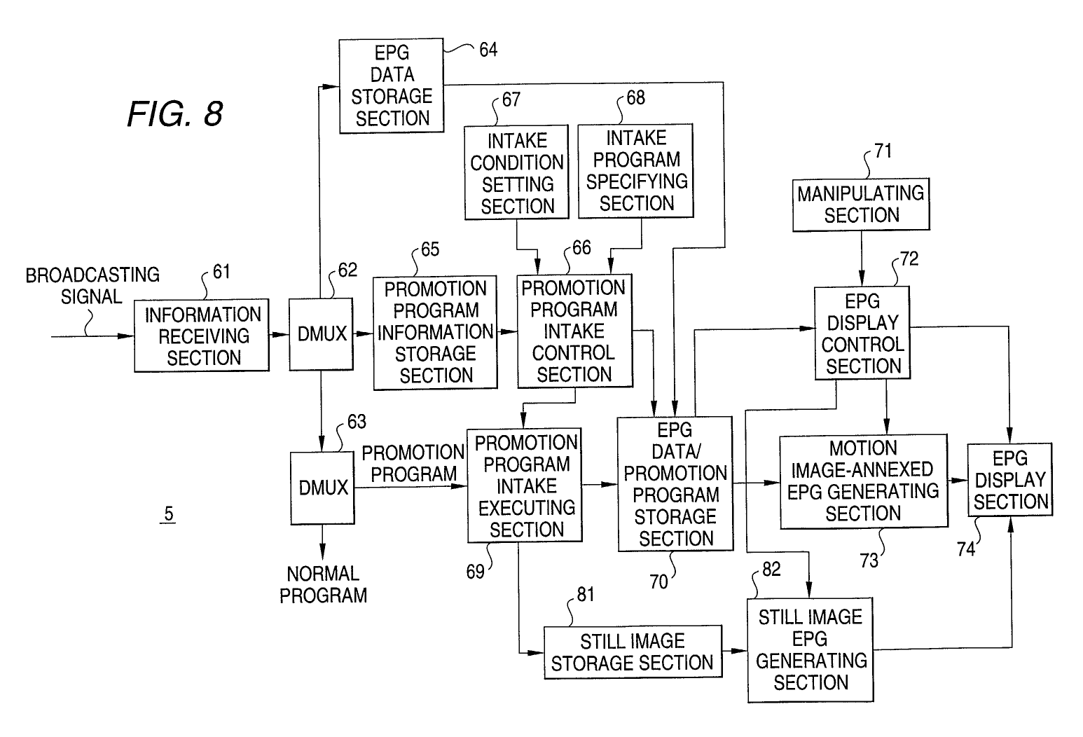

When the scene broadcasting time is to be included in the promotion program information in the transmitter 1, the receiver 5 in FIG. 1 may be arranged as shown in FIG. 8 for example.

That is, FIG. 8 shows the other structural example of the receiver 5. It is noted that the components in the figure corresponding to those in FIG. 5 are denoted by the same reference numerals.

A still image storage section 81 and a still image EPG generating section 82 are provided anew in this embodiment.

In this case, the promotion program intake control section 66 controls the promotion program intake executing section 69 based on the promotion program information stored in the promotion program information storage section 65 and the information from the intake condition setting section 67. Thereby, the promotion program intake executing section 69 takes out a still image which is one scene corresponding to the scene broadcasting time, beside necessary motion images, from the promotion program outputted from the DMUX 63.

That is, a condition whether or not to take in the still image is set as an intake condition in the intake condition setting section 67 in this case. When the condition is set to take in the still image, the promotion program intake control section 66 outputs the scene broadcasting time included in the promotion program information to the promotion program intake executing section 69 together with the information necessary for taking in the motion images as described above.

While the promotion program intake executing section 69 takes in the motion images based on the information from the promotion program intake control section 66 and supplies them to the EPG data/promotion program storage section 70 as described above, it also takes in the scene corresponding to the scene broadcasting time sent from the promotion program intake control section 66 from the output of the DMUX 63 and supplies it to the still image storage section 81.

The still image storage section 81 stores the scene (the still image) sent from the promotion program intake executing section 69. It is noted that when the motion images promoting the ordinary program are MPEG-encoded for example, an image obtained by decoding the MPEG-encoded image for example is stored in the still image storage section 81 as the still image. However, it is also possible to store the image in the encoded state as it is.

Then, when the user manipulates the manipulating section 71 so as to display EPG of a list of still images of programs, a still image listing screen composed by arraying certain scenes (scenes to be broadcasted at the time specified by the scene broadcasting time) of the motion images promoting the ordinary programs is displayed.

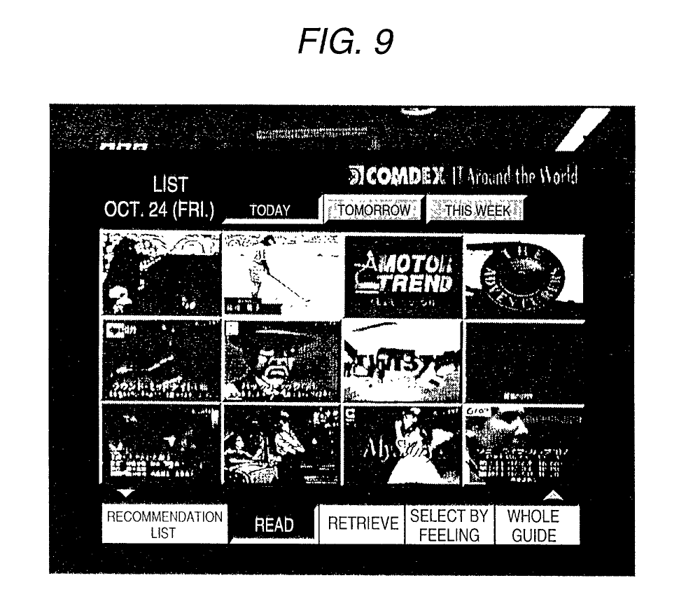

That is, in this case, the EPG display control section 72 reads the still image from the still image storage section 81 by controlling the still image EPG generating section 82 to compose the still image listing screen. This still image listing screen (the still image EPG) is supplied to the EPG display section 74. Thereby, the EPG display section 74 displays the still image listing screen as shown in FIG. 9 for example. It is noted that the still images arrayed on the still image listing screen may be limited in the same manner with the case of the program selecting screen described above.

The still image part promoting each program displayed on the still image listing screen may be selected by manipulating the manipulating section 71. When the user manipulates the manipulating section 71 to select a still image part of a program to know the detail thereof for example, the screen detailing the program, i.e., the detailed screen shown in FIG. 7, is composed and is displayed instead of the still image listing screen in the receiver 5.

Because the program selecting screen shown in FIG. 6 is composed by arraying the titles of the programs, it is difficult for the user to comprehend the outline of a program without reading the title. However, because the still image listing screen is composed by arraying certain scenes composing the motion images promoting the ordinary programs, the user can comprehend the outline of the program at first sight.

While the case when the present invention is applied to the broadcasting system transmitting programs via the satellite line has been explained above, the present invention is applicable in transmitting programs also via the CATV (cable television) network, the ground wave and the like.

It is noted that although all of the ordinary programs, the promotion programs, the EPG data and the promotion program information have been transmitted via the satellite line in the embodiment described above, they need not to be transmitted always through the same transmitting medium. That is, it is possible to transmit the ordinary program, the promotion program and the EPG data through the satellite line and to transmit the promotion program information by a telephone line, respectively, for example.

Further, although not mentioned specifically in the embodiment described above, the information stored in the EPG data storage section 64, the promotion program information storage section 65, the EPG data/promotion program storage section 70 and the still image storage section 81 is erased periodically or after an elapse of a predetermined time since when it has been stored or at other required timing.

Although it is necessary to select a channel broadcasting a promotion program in order to store (record) the promotion program, there is a case when the user selects another channel during the selection. While it is possible to store the promotion program and to view the channel selected by the user when there are a plurality of tuners for selecting channels, it is impossible to implement the both when there is only one tuner. Then, it is desirable to stop to store the promotion program and to precede the channel selected by the user in such a case.

Further, although the promotion program information has been handled equally, so to speak, with the ordinary program, the promotion program and the EPG data and has been multiplexed and transmitted by the MUX 20 of the transmitter 1 in the embodiment described above, it is possible to transmit the promotion program information by disposing in program related information which is part of data of the promotion program for example.

Accordingly, while the preferred embodiment has been described, variations thereto will occur to those skilled in the art within the scope of the present inventive concepts which are delineated by the following claims.

What is claimed is:

1. An information processing apparatus for processing a promotion program for promoting ordinary programs, comprising generating means for generating promotion program information correlating information on said promotion program and information on said ordinary programs to be promoted by said promotion program.

2. The information processing apparatus according to claim 1, wherein the information on said promotion program contains at least information on a channel broadcasting said promotion program and on time or hour and the information on said ordinary program contains at least information for specifying said ordinary program.

3. The information processing apparatus according to claim 1, further comprising transmitting means for transmitting said promotion program and said promotion program information together with program guide information for giving a guide on said ordinary programs.

4. An information processing method for processing a promotion program for promoting ordinary programs, comprising a step of generating promotion program information correlating information on said promotion program and information on said ordinary programs to be promoted by said promotion program.

5. An information processing apparatus for processing transmission data, comprising, when said transmission data contains at least a promotion program for promoting ordinary programs, program guide information for giving a guide on said ordinary programs and promotion program information correlating information on said promotion program and information on said ordinary programs to be promoted by said promotion program:
separating means for separating said promotion program, said program guide information and said promotion program information from said transmission data; and
storage means for correlating and storing the promotion program and the program guide information of the same ordinary program based on said promotion program information;
promotion program-annexed program guide information in which said program guide information about the ordinary program and said promotion program correlated with the program guide information are composited being provided when said program guide information about said ordinary program is requested.

6. The information processing apparatus according to claim 5, wherein the information on said promotion program contains at least information on a channel broadcasting said promotion program and on time or hour and the information on said ordinary program contains at least information for specifying that ordinary program.

7. The information processing apparatus according to claim 5, characterized in that the processor further comprises specifying means for specifying said ordinary program and said storage means correlates and stores said promotion program and said promotion program information about said ordinary program specified by said specifying means.

8. The information processing apparatus according to claim 5, wherein said storage means stores a still image which is one scene within motion images composing said promotion program.

9. The information processing apparatus according to claim 8, wherein the information on said promotion program contains time information on the time when the scene as said still image is to be broadcasted and said storage means stores the still image which is one scene within motion images composing said promotion program based on said time information.

10. The information processing apparatus according to claim 8, wherein still image-annexed program guide information in which said program guide information about the ordinary program and said still image about said promotion program correlated with the program guide information are composited is provided when said program guide information about said ordinary program is requested.

11. The information processing apparatus according to claim 8, further comprising generating means for generating a still image arrayed screen in which still images about a plurality of said promotion programs stored in said storage means are arrayed.

12. An information processing method for processing transmitted data, comprising steps of, when said transmitted data contains at least a promotion program for promoting ordinary programs, program guide information for giving a guide on said ordinary programs and promotion program information correlating information on said promotion program and information on said ordinary programs to be promoted by said promotion program:
separating said promotion program, said program guide information and said promotion program information from said transmission data; and
correlating and storing said promotion program and said program guide information of the same ordinary program based on said promotion program information;
promotion program-annexed program guide information in which said program guide information about the ordinary program and said promotion program correlated with the program guide information are composited being provided when said program guide information about said ordinary program is requested.

13. A broadcasting system comprising a transmitter for transmitting transmission data and a receiver for receiving the transmission data from said transmitter, wherein said transmitter comprises:
generating means for generating promotion program information correlating information on a promotion program and information on ordinary programs to be promoted by said promotion program; and
transmitting means for transmitting said promotion program and said promotion program information together with program guide information for giving a guide on said ordinary programs as said transmission data; and
said receiver comprises:
separating means for separating said promotion program, said program guide information and said promotion program information from said transmission data; and
storage means for correlating and storing said promotion program and said program guide information of the same ordinary program based on said promotion program information;
promotion program-annexed program guide information in which said program guide information about the ordinary program and said promotion program correlated with the program guide information are composited being provided when said program guide information about said ordinary program is requested.

14. A broadcasting method of a broadcasting system comprising a transmitter for transmitting transmission data and a receiver for receiving the transmission data from said transmitter, comprising steps of:
generating promotion program information correlating information on a promotion program and information on ordinary programs to be promoted by said promotion program; and
transmitting said promotion program and said promotion program information together with program guide information for giving a guide on said ordinary programs as said transmission data in said transmitter; and
separating said promotion program, said program guide information and said promotion program information from said transmission data; and
correlating and storing said promotion program and said program guide information of the same ordinary program based on said promotion program information in said receiver;
promotion program-annexed program guide information in which said program guide information about the ordinary program and said promotion program correlated with said program guide information are composited being provided when said program guide information about said ordinary program is requested.
